(19) United States
(12) Patent Application Publication
(10) Pub. No.: US 2025/0328786 A1
(43) Pub. Date: Oct. 23, 2025

(54) TOWARDS AUTOMATED AND RELIABLE LLM EVALUATION: A FRAMEWORK TO EVALUATE LLMS AND FIND SUITABLE AUTOMATIC METRICS TO REDUCE THE HUMAN IN THE LOOP

(71) Applicant: Dell Products L.P., Round Rock, TX (US)

(72) Inventors: Jonathan Mendes De Almeida, Brasília (BR); Luiz Fernando Sommaggio Coletta, Tupã (BR); Micael Veríssimo de Araújo, Rio de Janeiro (BR); Pablo Nascimento da Silva, Niterói (BR)

(21) Appl. No.: 18/642,573

(22) Filed: Apr. 22, 2024

(51) Int. Cl. G06N 5/04

(52) U.S. Cl. CPC G06N 5/04

(57) ABSTRACT

One example method includes obtaining, for a benchmark question, a respective answer to the benchmark question generated by each model of a group of models, computing respective automated metrics for each of the answers, randomly selecting a battle between first and second models of the group and, for the automated metrics that respectively correspond to the answers generated by the first model and the second model, determining a respective difference between those automated metrics and a threshold, determining, based on the respective differences, whether or not a human evaluation of the battle is needed, using a set of agents to determine, by voting of the agents, as between the answer of the first model and the answer of the second model, which answer is better, and performing, based on the voting and the automatic metrics, an adherence evaluation to identify a best performing model out of the group of models.

### TECHNOLOGICAL FIELD OF THE DISCLOSURE

Embodiments disclosed herein generally relate to large language models (LLMs). More particularly, at least some embodiments relate to systems, hardware, software, computer-readable media, and methods, for evaluating the performance of LLMs, while minimizing human involvement in a way that does not materially compromise results obtained with the evaluation process.

### BACKGROUND

Chatbots, and other mechanisms, based on generative AI tools such as Large Language Models (LLMs) are becoming increasingly popular. Due to their effective performance in handling a broad range of natural language tasks and domain-specific ones, LLMs are becoming a common mechanism for enterprises to provide support to customers and partners. Thus, evaluating the performance of such LLM-based systems has become increasingly important, attracting significant interest from the academia and the industry. However, evaluation of LLM performance is not a trivial task and there is no single approach for addressing this problem. Significant efforts have been made to properly examine and evaluate LLMs from different perspectives.

Two LLM performance evaluation methods include automatic evaluation, based on metrics that can be automatically calculated, and human evaluation, that is, manual evaluation performed by humans. Various different metrics for automatic evaluation of LLMs have been proposed. However, providing a reliable evaluation framework for LLM-based systems without a human in the loop is very challenging. In many use cases, such as open generation and open domain question and answering tasks, the usage of automatic evaluation metrics alone, such as BERTScore, can result in erroneous conclusions, while human evaluation may be considerably more accurate. However, manual evaluation of large amounts of data is costly and even infeasible in some cases. Conversely, automatic evaluation does not require direct human participation, which improves applicability while reducing the associated evaluation cost, that is, monetary and time. Therefore, there is a challenging tradeoff between evaluation reliability and cost.

Within that context, there are at least two significant challenges related to LLM-based systems evaluation. For example, considering the vast number of LLMs and metrics available in the literature, the challenge is how to determine the most suitable/reliable metric for a given task. Another challenge is that since the increasingly strengthened capabilities of LLMs have gone beyond the state-of-the-art evaluation metrics on general natural language tasks, manual evaluation can be the most reliable choice for evaluating LLMs. In this case then, the challenge is how to efficiently deal with the tradeoff between evaluation reliability and cost.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a method according to one embodiment.

FIG. 2 discloses aspects of an LLM-based system battle according to one embodiment.

FIG. 3 discloses an example computing entity configured and operable to perform any of the disclosed methods, processes, and operations.

### DETAILED DESCRIPTION OF SOME EXAMPLE EMBODIMENTS

Embodiments disclosed herein generally relate to large language models (LLMs). More particularly, at least some embodiments relate to systems, hardware, software, computer-readable media, and methods, for evaluating the performance of LLMs, while minimizing human involvement in a way that does not materially compromise results obtained with the evaluation process.

One example embodiment comprises a method for evaluating the performance of an LLM using various automated metrics, while limiting human involvement in the evaluating to those circumstances where such human involvement is likely to provide a better outcome than a strictly automated evaluation process. One embodiment of such a method may comprise operations including: generating, by each LLM in a group of LLMs, respective answers to one or more questions to create a set of benchmark questions and corresponding benchmark answers; calculating automated evaluation metrics that indicate LLM performance with respect to the benchmark answers; using the automated evaluation metrics and the benchmark answers, performing a hybrid battle-based evaluation of the benchmark answers to generate votes for the LLMs; generating an Elo rating; using the automated evaluation metrics, Elo rating, and votes, determining which LLM can be expected to provide the best performance in terms of adherence to a human evaluation of the LLMs.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiments is that the efficiency, in terms of time and/or cost for example, of a process to evaluate LLM performance may be improved. An embodiment may reduce human involvement in an LLM evaluation process while maintaining the effectiveness and efficiency of the LLM evaluation process. An embodiment may call for human involvement in an LLM evaluation process only when necessary to meet one or more criteria relating to the LLM evaluation process. Various other advantages of one or more example embodiments will be apparent from this disclosure.

### A. REFERENCES

Various references may be referred to herein. These references are listed below and incorporated herein in their entirety by this reference. References to these herein will be made using the [X] numbers indicated below.
[1] Y. Chang et al., “A Survey on Evaluation of Large Language Models.” arXiv, Aug. 28, 2023. Accessed: Oct. 16, 2023. [Online]. Available: http://arxiv.org/abs/2307.03109.
[2] T. Zhang, V. Kishore, F. Wu, K. Q. Weinberger, and Y. Artzi, “BERTScore: Evaluating Text Generation with BERT.” arXiv, Feb. 24, 2020. doi: 10.48550/arXiv.1904.09675.
[3] G. Penedo et al., “The RefinedWeb Dataset for Falcon LLM: Outperforming Curated Corpora with Web Data, and Web Data Only.” arXiv, Jun. 1, 2023. Accessed: Oct. 25, 2023. [Online]. Available: http://arxiv.org/abs/2306.01116.
[4] A. Q. Jiang et al., “Mistral 7B.” arXiv, Oct. 10, 2023. Accessed: Oct. 25, 2023. [Online]. Available: http://arxiv.org/abs/2310.06825.
[5] Vaswani, A., Shazeer, N., Parmar, N., Uszkoreit, J., Jones, L., Gomez, A. N., Kaiser, Ł., and Polosukhin, I. (2017). Attention is all you need. Advances in neural information processing systems, 30.
[6] L. Zheng et al., “Judging LLM-as-a-Judge with MT-Bench and Chatbot Arena.” arXiv, Oct. 15, 2023. Accessed: Available: Oct. 25, 2023. [Online]. http://arxiv.org/abs/2306.05685.

### B. CONTEXT FOR AN EXAMPLE EMBODIMENT

Following is a discussion of aspects of a context for one example embodiment. This discussion should not be construed as limiting the scope of this disclosure or the claims, or limiting the applicability of any embodiment in any way.

### B.1 Large Language Models

Language Models (LMs) are models that can understand and generate human language by predicting the likelihood of word sequences or generate text based on a given input. Recently, the architecture and training methods of LMs have improved considerably and Large Language Models (LLMs) have emerged in the literature. LLMs are advanced LMs with massive parameter sizes and exceptional learning capabilities. The core module of such models is the self-attention module in Transformer (see [5]), which revolutionized the field of natural language processing due to its ability to deal with sequential data. An important characteristic of LLMs is their ability to generate text based on a given context or prompt. This in-context learning feature enables LLMs to generate coherent and contextually relevant responses, making them well suited for interactive and conversational applications, such as chat assistants, that is, LLM-based system/chatbots. In this context, LLMs have revolutionized the natural language processing research area and their practical application is broadly spreading in various domains. Nonetheless, measuring the performance of LLMs is still an open challenge. Following is a brief introduction on LLM performance evaluation.

### B.2 LLM Performance Evaluation

Evaluating the performance of LLM-based systems is challenging due to the combination of their broad capabilities and the inadequacy of existing benchmarks in measuring human preferences. The evaluation methods may generally be divided into two categories based on whether or not the evaluation criterion can be automatically computed, or is manually determined. That is, the two categories are: automatic evaluation, that is, the evaluation of the LLM can be automatically calculated, and manual evaluation, that is, evaluation of the LLM requires human involvement to perform the evaluation.

### B.2.1 Automatic Evaluation

Automatic evaluation of LLMs, that is, LLM performance, is based on metrics/indicators, such as BERTScore for example, that measure the performance of the models. Such metrics quantify the similarity and quality between (1) the model-generated answer and (2) the expected answer. For example, BERTScore computes a similarity score for each token in the generated answer with each token in the expected answer based on contextual embeddings, rather than relying on exact matches. Due to their automaticity and simplicity, most of the existing LLM evaluation efforts adopt such kind of evaluation protocol, which can be very reliable for considerably deterministic tasks, such as natural language understanding and math problems. Compared with manual evaluation, automatic evaluation does not require intensive human participation, which saves a considerable amount of capital expenditure and time. Nonetheless, the capabilities of LLMs are growing exponentially and have already gone beyond standard evaluation metrics usually used on general/deterministic natural language tasks. In this context, human evaluation has been employed both in academia and industry to evaluate some non-deterministic/standard use cases where the usage of automatic evaluation is not able to provide relevant insights.

### B.2.2 Manual Evaluation

In non-deterministic/standard use cases such as in open generation tasks where automatic evaluation is based on embedded similarity metrics, for example, are not enough, it may be better to employ manual evaluation to obtain a more reliable evaluation of LLM performance. In a manual LLM evaluation procedure, evaluators, such as experts, researchers, and/or end users for example, are invited to assess the results generated by the LLM. This procedure is usually performed by creating anonymous “battles,” using question-answer tuples, between different LLMs in real-world scenarios, where, for example, users can engage in conversations with two LLM-based systems/chatbots, using different models, at the same time and rate their responses. In such cases, when compared with automatic evaluation, manual evaluation can provide more comprehensive/accurate feedback and, consequently, makes the LLM performance evaluation conclusions more reliable.

### B.2.3 Elo Rating

The Elo rating is used for computing the relative skill levels of players in games and/or sports. Elo rating has also been increasingly recognized as a useful performance measure for LLMs, which can be used as a tool to compute a performance metric based on the data obtained via manual evaluation procedure, as described above. In this case, the Elo rating is an efficient criterion suited for use with a manual evaluation, in which multiple models (players) need to be assessed through a series of pairwise battles (matches) between them.

In more detail, the difference in the respective ratings of the two models serves as a predictor of the battle outcome. For example, considering that model A has a rating of R_{A} and model B a rating of R_{B}, the probability of model A winning the battle is given by the following formula

$${E}_{A} = \frac{1}{1 + {10}^{( {R}_{B} - {R}_{A} ) / 400}} .$$

The ratings of models can be linearly updated after each battle. For example, supposing model A was expected to reach E_{A} but actually obtained S_{A}, the following formula R′_{A}=R_{A}+K·(S_{A}−E_{A}) indicates the updated rating for model A. Since it is desirable that an evaluation system be able to evaluate a new model using a relatively small number of trials, the Elo rating may be useful in an embodiment since it provides that property.

With this context in view, the inventors are unaware of any existing framework able to determine the most suitable automated evaluation metrics while also dealing with the tradeoff between evaluation reliability and cost of LLM-based systems. Thus, an embodiment may address these considerations by defining and using an evaluation framework that is able to compare models used in LLM-based systems, and that is able to indicate the most suitable metric for a given benchmark/set of metrics, while minimizing the dependency on human evaluation that may be expensive and time-consuming. More particularly, an example embodiment may comprise a method to determine the most suitable automated evaluation metrics for a given benchmark and a set of metrics, and/or may comprise a method to compare LLMs performance while dealing with the tradeoff between evaluation reliability and cost.

### C. OVERVIEW OF ASPECTS OF AN EXAMPLE EMBODIMENT

One example embodiment comprises a framework and method to address the challenges related to the evaluation of LLM-based systems. In one embodiment, the framework may be executed in three main phases: computation of responses of each LLM being used (Phase 1), computation of evaluation metrics (Phase 2), and adherence evaluation to select the most suitable metrics (Phase 3). These phases are described in turn below.

### Phase 1—Compute Initial Responses

1. Starts with a benchmark containing tuples of questions (q∈Q) and expected answers (a∈A), and a set of LLMs (m∈M)
2. For each model m (m∈M) being used in the LLM-based system (such as Falcon and Mistral, for example), generate an answer for all questions (q∈Q)
3. Returns tuples of questions (q∈Q) and answers (rₘ∈Rₘ) for each LLM (m∈M)

Phase 2-Compute evaluation metrics
1. Starts with the benchmark questions (q∈Q) and answers (rₘ∈Rₘ) for all LLM models (m∈M)
2. In the Automatic Evaluation Module (AEM), compute the automated metrics e∈E for each answer rₘ∈Rₘ of each LLM m∈M used in the system. An automatic metric may be, for example, the BERTScore. After one iteration, the metrics values are then sorted according to their adherence score computed in Phase 3, discussed below, in order to prioritize the most adherent metrics in the following evaluation procedures.
3. The Hybrid Evaluation Module (HEM) receives the metrics (e∈E) computed by the AEM, the answers (rₘ∈Rₘ) generated by all LLMs (m∈M), and orchestrates the manual LLM-based system evaluation made by humans and the automated LLM-based system evaluation based on LLM agents:
   a. Manual LLM-based system evaluation: before getting human evaluation responses, the LLM-based system battle optimizer, or simply the ‘optimizer,’ randomly selects “battles” between two LLMs, that is, the LLM-based system battle optimizer will randomly select a question from the benchmark and get the answers generated by the two selected LLM,) and for each metric, the optimizer computes the difference between the metric value obtained by each LLM-then, based on user-defined thresholds:
      i. If the metric values for both models are distant (i.e., the difference between the metric value of each model is higher than the defined threshold), it indicates that one model is possibly better than the other and no human evaluation battle is needed. This procedure can be adjusted according to constraints related to the human availability for manual evaluation.
      ii. If the metric values for both models are close (i.e., it is lower than the defined threshold), it means that the response of the two selected models are possibly close and it is better to proceed with a manual evaluation (i.e., display this battle for human evaluation).
   b. Automatic LLM-based system evaluation: the automatic evaluation module uses a set of LLM agents that are supposed to act as humans. In other words, the automatic evaluation module creates a prompt designed to compare two answers for a specific question and each LLM agent will vote for the best answer and the model with more votes wins the battle. This procedure repeats until reach all battle combinations or reach a user-defined threshold.
4. After carrying out the automatic and manual evaluation, compute the Elo rating and proceed to Phase 3.

### Phase 3—Select Suitable Metrics

Based on all automatic evaluation metrics, such as the BERTscore for example, and manual votes obtained by the Hybrid Evaluation Module, using Manual LLM-based system evaluation, the adherence evaluation returns the most reliable automatic metric to be used by the LLM-based system battle optimizer (in Phase 2), and a rank to indicate which is the best LLM model. Specifically, the adherence evaluation takes advantage of battles between LLMs and their tested performance by the metrics to measure the agreement between automatic evaluation and human manual votes:
a. Given the answers rₘ₁∈Rₘ₁ and rₘ₂∈Rₘ₂ from two different models (m₁≠m₂ and m₁, m₂∈M) to the same question, q∈Q, an agreement is counted, that is, a_{q}=1, when the answer with the most votes (rₘ₁ Or rₘ₂) is the same as the one with the highest value calculated by a metric e∈E.
b. Assuming the agreement, ag, for different questions in Q and battles (rₘ₁ versus rₘ₂), with several votes, an embodiment may average a_{q} by each metric in E so that a ranking of metrics is obtained.
c. From b. (above), an embodiment may obtain the most reliable automatic metric in E, in adherence with manual evaluation done by humans, and, by observing this metric and votes by models in M, the best LLM model can be displayed.

### D. DETAILED DISCUSSION OF ASPECTS OF AN EXAMPLE EMBODIMENT

### D.1 Introduction

Currently, there is no one-size-fits-all evaluation metric for use in evaluating the performance of LLMs. Rather, current convention typically either assumes that one or more metrics are suitable, which can result in inaccurate conclusions, or employs a fully manual evaluation approach, which can be extremely costly. In this context, an embodiment may comprise various elements to address these circumstances. For example, an embodiment may comprise a method to determine the most suitable automated evaluation metrics for a given benchmark from a set of possible metrics applied in LLMs evaluation. As another example, an embodiment may comprise a framework to evaluate the performance of LLM-based systems, while at the same time dealing with the tradeoff between evaluation reliability, and cost, in a way to minimize the usage of manual evaluation without compromising the reliability of the evaluation performed.

To assess the quality of open question answering systems, such as LLM-based system/chatbots for example, specialized evaluators may be needed that commonly employ metrics for content similarity, and large human evaluation procedures. However, human evaluation is expensive, and human evaluation alone may not be successful since each human has their own view and bias when judging generated responses. To mitigate this problem, an embodiment comprises a framework to evaluate the performance of LLMs, and LLM-based systems, by minimizing the usage of manual evaluation, and leveraging the use of automated metrics, but without materially compromising the evaluation reliability. One embodiment achieves these ends by determining the most suitable automated evaluation metrics for a given benchmark dataset and a set of metrics, while also dealing with the tradeoff between evaluation reliability and cost.

A framework according to one embodiment is based on so-called battles between two different LLMs, or other models. To assess the winner of each battle, an embodiment may use a human evaluation of LLM performance, or a metric-based evaluation of LLM performance. In an ideal world, the whole system would work with metric evaluation alone, but such an approach is not feasible since there are many types of answer that metrics do not handle well.

To overcome this problem, one embodiment may implement an optimized battle, between/among two or more models. Those battles with low confidence metrics may then be sent to a human evaluator for consideration. In this way, an embodiment may indicate a high probability that the model is being fairly evaluated in those areas where the metrics, alone, may not provide an accurate evaluation of the model.

Another aspect of a framework according to one embodiment is the use of an Elo rating procedure to rank all the models in the system. In this way, an embodiment may enable recent models to compete with old models, which possibly would have higher voting numbers. Elo ratings may be used in an embodiment to assess the quality of the model against its pairs when the winner model wins points based on the quality (Elo) of the adversarial model. Additionally, an embodiment may employ an adherence metrics procedure to help measure the quality of the metrics against human evaluations. This may provide some extra quality in the usage of the metrics since the metrics may be ranked from best to worse relative to any given benchmark dataset.

### D.2 Discussion

As noted earlier, an embodiment may comprise, and be executed in, three phases.

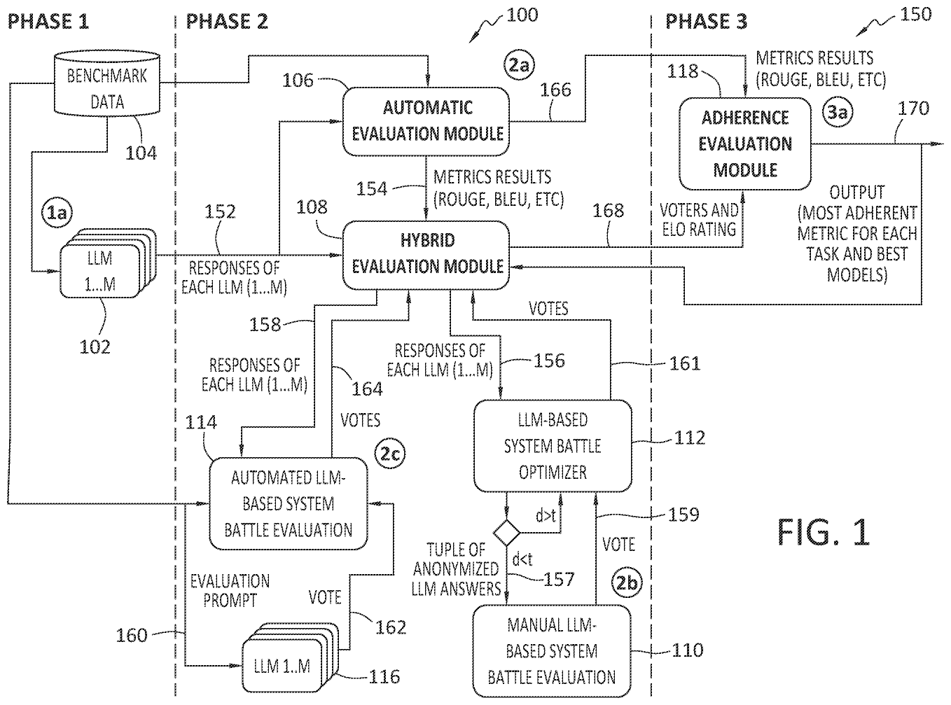

This is indicated in the architecture 100 and method 150 of FIG. 1. In particular, the procedures of an embodiment may be executed in the following three phases:
1. Phase 1—compute the response for each LLM and proceed to Phase 2;
2. Phase 2—compute all the evaluation metrics, both automatic and manual, and proceed to Phase 3; and
3. Phase 3—execute the adherence evaluation to select the most suitable metrics and return, that is, identify, the best LLM.

### D.2.1 Phase 1 and 2-LLM Responses Computation

In an embodiment, Phase 1 may comprise a process to obtain answers from all LLMs 102 from the set M considering the benchmark questions. Stage 1a of FIG. 1 encompasses the Phase 1 procedure, which may comprise the following operations:
1. start with a benchmark dataset 104 containing tuples of questions (q∈Q) and expected answers (a∈A), and a set of LLMs 102 (m∈M);
2. for each model m (m∈M) being used in the LLM-based system (such as Falcon or Mistral for example), generate an answer for all questions (q∈Q);
3. return tuples 152 of questions (q∈Q) and answers (rₘ∈Rₘ) for each LLM (m∈M); and
4. proceed to Phase 2.

In Phase 2, after receiving the answers (rₘ∈Rₘ) generated during Phase 1, the AEM 106 runs Stage 2a, as shown in FIG. 1, by accessing the expected answers (a∈A) for each question (q∈Q) and computing the automated metrics (e∈E) for each model m∈M. For example, one embodiment may employ the following metrics: cosine similarity; BERTScore; BLEU; ROUGE; Meteor; BLEURT; and Perplexity. From one complete iteration on, the metrics values may then be sorted according to their adherence score, computed in Phase 3 as discussed below, in order to prioritize the most adherent metrics in the following evaluation procedures.

It is noted that as used herein, adherence of a metric is a measurement or indication of the extent to which the evaluation of the performance of a model with that metric matches or conforms to a human evaluation of the performance of that same model. Thus, a relatively highly adherent metric would indicate that the evaluation of the performance of a model by that metric closely matches the evaluation of the performance of that same model by a human, while a metric with low adherence would indicate that the evaluation of the performance of the model by that metric differs, possibly substantially, from a human evaluation of the performance of that model. As disclosed elsewhere herein, one embodiment may employ battles between models and their tested performance by the metrics to measure the agreement between automatic evaluation and human manual votes, that is, to measure the adherence of the metrics.

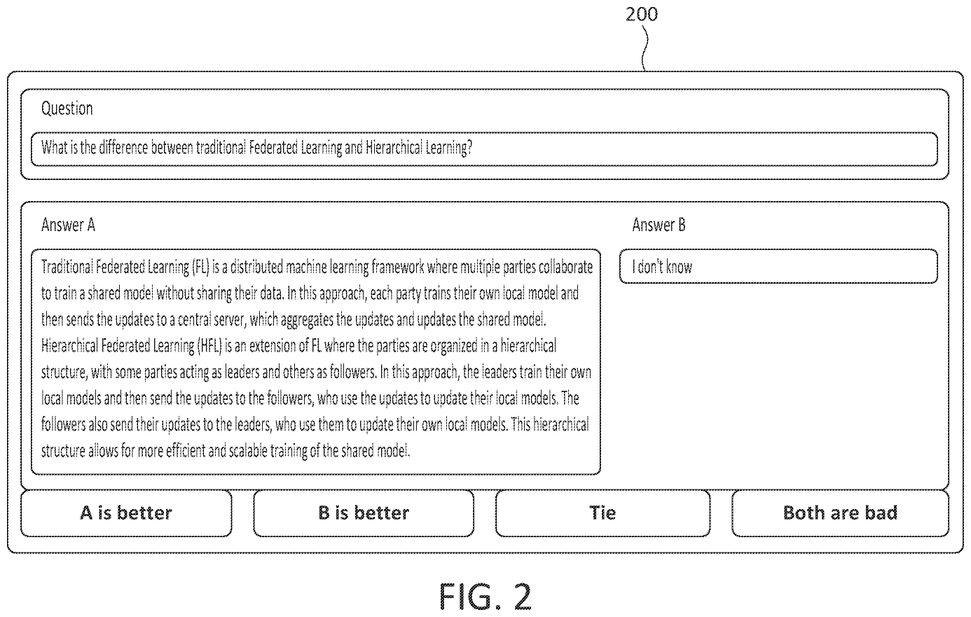

Continuing now with the discussion of FIG. 1, based on the metrics computed by the AEM 106, the HEM 108 receives 154 these metrics values and proceeds with the LLM “battle” evaluation procedure where the answers generated by different LLMs will be evaluated. As used here, a battle refers to a confrontation between the answers of two different LLMs, or between different fine-tuned versions of the same LLM. That is, a battle for a given question is composed of answers generated by a tuple of LLMs, such as Falcon and Mistral for example. An example of a battle is denoted at 200 in FIG. 2. Based on how the battles will be judged, the LLM comparison procedure may be performed manually and/or automatically.

An example manual battle evaluation, which may be implemented by a manual LLM-based battle evaluation module 110, or ‘module 110,’ may take place in Stage 2b disclosed in FIG. 1, whose operations are preceded by operations performed by a manual LLM-based system battle optimizer, or ‘optimizer,’ 112, which may operate to optimize the generating battles by selecting the most relevant battles to be prompted to a human evaluator. Here, the relevant battles are those where the answers for two different models are close in terms of metrics values, and where, after the first iteration, the metrics are prioritized according to their adherence score computed in Phase 3. In other words, the optimizer 112 will select battles for which it may be more valuable to have a human deciding which answer is better, since the metrics values of the respective answers of the models in the battles are relatively close to each other.

An intuition behind this optimization procedure implemented by the optimizer 112 is that battles where the metrics values for one LLM are considerably higher than the metrics values calculated for its opponent, that is, another LLM, may be considered to be less relevant than battles where both models present similar metric results. The decision for a battle is may be more direct for the first case where an LLM distinguishes itself from the other in view of its large advantage when looking at the metric values. Conversely, when the respective metrics values of two models are closer, it may be better to get a manual validation of the model performances. A threshold based on the proximity of the metric values may be adopted in this case to control the sensitivity of this optimization procedure, that is, to help determine whether a manual validation by a human should be performed or not.

It is noted that if the human availability for manually evaluating battles is unlimited, which is not the case in real world scenarios, the optimizer 112 may sort, possibly in ascending order, the battles according to the metrics differences between the LLMs of each battle, and then send a prompt to the human evaluator in that order. In this case, the number of battles submitted to a human for evaluation is subject to the human availability, and the optimizer 112 may provide a mechanism to deal with the tradeoff between evaluation reliability and cost.

The last stage in Phase 2, that is Stage 2c disclosed in FIG. 2, involves the automatic battle evaluation implemented by an automated LLM-based system battle evaluation module 114, which utilizes specialized LLMs that are fine-tuned to select the best answer, received 158 from the HEM 108, for a given question, based on a reference answer. In one embodiment, the specialized prompts for LLM judges may be implemented as presented and validated in [6], although this approach is not required in any case, and does not exclude the use of alternative approaches. In other words, such LLMs are trained to receive two answers for a given question, that is, a battle, and then act, based on the prompts 160, as human judges so as to consequently reduce the need to have a human in the evaluation loop. The output of the LLMs 116 may be provided as votes 162 to the module 114, which may then pass 164 those votes to the HEM 108.

With continued attention to the example of FIG. 1, an embodiment of Phase 2 may proceed as follows:
1. start with the benchmark questions (q∈Q) and answers (rₘ∈Rₘ) for all LLM models (m∈M);
2. in the AEM 106 (Stage 2a), compute the automated metrics e∈E for each answer rₘ∈Rₘ of each LLM m∈M used in the system. After one iteration, the metrics values are then sorted according to their adherence score computed in Phase 3 in order to prioritize the most adherent metrics in the following evaluation procedures;
3. the HEM 108 receives 154 the metrics (e∈E) computed by the AEM 106, the answers (rₘ∈Rₘ) generated by all LLMs (m∈M), and orchestrates the manual LLM-based system evaluation made by humans and the automated LLM-based system evaluation based on LLM agents:
   a. in the manual LLM-based system evaluation procedure (Stage 2b), evaluators, such as experts, researchers, and/or end users for example, are invited to assess the results generated by the LLM—this procedure may be performed by creating anonymous “battles,” using question-answer tuples, between different LLMs in real-world scenarios, and these anonymized battles may be provided 157 to the module 110.
   b. operations performed by the module 110: before receiving human evaluation responses, the LLM-based system battle optimizer 112 randomly selects “battles” between two LLMs—that is, the optimizer 112 randomly selects a question from the benchmark and receives 156 the respective answers generated by the two selected LLMs, which are output 157 as tuples of anonymized answers to the module 110 and, for each metric, and based on the votes received 159 from the module 110, and ultimately returned 161 to the HEM 108, the optimizer 112 computes the difference between the values obtained for each LLM-then, based on user-defined thresholds:
      i. if the respective metric values for the models are distant, that is, the difference between the metric value of each model is higher than the defined threshold, this condition indicates that one model is possibly better than the other with a considerable advantage that expresses reliability in this assertion, such that no human evaluation battle is needed. This procedure may be adjusted according to constraints related to the human availability for manual evaluation; or
      ii. if the metric values for both models are close, that is, the respective metric values for the models are lower than the defined threshold, this condition indicates that the respective responses of the two selected models are possibly indistinguishable and it may be better to proceed with a manual evaluation, that is, display this battle for human evaluation, to attempt to reduce or avoid uncertainties in the system.
   c. Automatic LLM-based system evaluation (Stage 2c), performed by the automated LLM-based system battle evaluation module 114 or ‘automatic evaluation module 114’: the automatic evaluation module 114 uses a set of LLM agents that are configured to act as humans—that is, the automatic evaluation module 114 creates a prompt designed to compare two answers for a specific question and each LLM agent will vote for the best answer. The model with more votes wins the battle. This procedure repeats until all battle combinations have been considered, or until the number of battle combinations that has been considered reach a user-defined threshold.
4. After carrying out the automatic and manual evaluation, compute the Elo rating, as described earlier herein, and proceed to Phase 3.

### D.2.2 Phase 3-Adherence Evaluation

With continuing attention to FIG. 1, Phase 3 of an example embodiment comprises the Stage 3a, which may involve the operation of an adherence evaluation module 118 that may, in general, receive, and operate on, respective inputs 166 and 168 from the AEM 106 and from the HEM 108. In more detail, Stage 3a of an embodiment comprises performing an adherence evaluation from metric values computed by the AEM 106 (Stage 2a) and battles verdict from the manual evaluation (Stage 2b). Stage 3a may provide a determination as to how reliable a given metric is taking into the account its adherence to the human understanding expressed by voting in the battles. So, the adherence evaluation will provide a ranking of metrics (in E) those best matches to the human evaluation. From this, the best LLM model will also be output 170, or otherwise indicated to a user.

In one embodiment, Stage 3a may proceed as follows:
1. assuming a battle between distinct models, mᵢ and mⱼ from M, in which the models each answer a question q∈Q with responses rᵢ and rⱼ, respectively, the total number of votes for the best response (rᵢ or rⱼ) is counted as being Vᵢ and Vⱼ, respectively—from this, it can be stated that if Vᵢ is greater than Vⱼ, the model mⱼ answer (rᵢ) is likely to be better than that provided by model mⱼ (rⱼ), and vice-versa;
2. given now two scores/values, Sᵢ and Sⱼ, provided by a metric e∈E, respectively, for the answers rᵢ and rⱼ (in 1. above), the logic to find which one is the best response, according to e, is the same as discussed above, that is, if Sᵢ>Sⱼ then the answer rᵢ is better than rⱼ, and vice-versa;
3. an agreement for the battles' answers analyzed in 1, and 2. above may come from a rule, which is based on the best answer according to the human evaluation (number of votes Vᵢ and Vⱼ) and the scores from a metric e (Sᵢ and Sⱼ):

$${a}_{q}^{e} = \{ \begin{matrix}1 , when ( ( {S}_{i} > {S}_{j} ) and ( {V}_{i} > {V}_{j} ) ) or ( ( {S}_{j} > {S}_{i} ) and ( {V}_{j} > {V}_{i} ) ) , \\ 0 , otherwise\end{matrix} .$$

The rule above simply observes that when Sᵢ and Vᵢ are greater than the corresponding Sⱼ and Vⱼ; or when Sᵢ and Vᵢ are lower than Sⱼ and Vⱼ, respectively, there is an agreement to count ‘1’ for the metric e, and any other possibility will not be counted ‘0’; and
4. finally, the weighted adherence between human evaluation and a metric e may be estimated by:

$${A}_{e} = {\sum }_{q ∈ Q} ( {a}_{q}^{e} * {t}_{q} ) / {t}_{Q}$$

where t_{q} and t_{Q} are the total number of votes for the question q, and the total number of votes considering all the questions (Q), respectively.

It is noted that when more than two models are available in M, the rule in 3. above must be applied by question (q) and considering distinct battles between the various models. Consider the case of distinct battles, b, when the pair of opponents answering q are different. For example, assuming a total of three models, the following are all the possible pairs b∈B={(m₁, m₂), (m₁, m₃), (m₂, m₃)} for a battle-so that, for a question q, three different battles can occur, each of which should be evaluated by 1, and 2. above to have the agreement computed distinctly in 3 . . . . Hence, Aₑ will have t_{q} as the total number of votes for a question q and battle b, and t_{Q} as the total number of votes for all questions answered by the same battle b.

Computing Aₑ (and summarizing) for each metric in E and ranking the resulting values, an embodiment may determine the most adherent metrics. By summing up the positive, that is, better, votes for each model in the different battles, as well as averaging scores of the best metrics, an embodiment may then rank and display which is the best model for the tested task/benchmark. In an embodiment, the Elo rating may be supplementary to this rank.

### D.2.3 Further Discussion

By following the procedures described above, a framework may be implemented that is operable to evaluate the performance of LLM-based systems while dealing with the tradeoff between evaluation reliability and cost. An embodiment may provide a mechanism to minimize the issues of relying on manual evaluation without compromising the evaluation reliability. Moreover, an embodiment of the framework provides a method to determine the most suitable automated evaluation metrics for a given benchmark from a set of possible metrics applied in LLMs evaluation. An embodiment may be particularly useful in, but is not limited to, scenarios where the budget for manual evaluation is constrained.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In an embodiment, any of the methods disclosed herein may be performed by an application hosted on a server that makes the functionality of the method(s), possibly as-a-Service, to one or more clients. In an embodiment, any of the methods disclosed herein may be performed by an application locally hosted at a client device, or client devices. More generally however, no particular hosting arrangement, or deployment of any disclosed method, is required in any particular embodiment.

### F. FURTHER EXAMPLE EMBODIMENTS

Following are some further example embodiments. These are presented only by way of example and are not intended to limit the scope of this disclosure or the claims in any way.

Embodiment 1. A method, comprising: obtaining, for a benchmark question, a respective answer to the benchmark question generated by each model of a group of models; computing respective automated metrics for each of the answers; randomly selecting a battle between a first one of the models and a second one of the models and, for the automated metrics that respectively correspond to the answer generated by the first model and the answer generated by the second model, determining a respective difference between those automated metrics and a threshold; determining, based on the respective differences, whether or not a human evaluation of the battle is needed; using a set of agents to determine, by voting of the agents, as between the answer of the first model and the answer of the second model, which answer is better; and performing, based on the voting and the automated metrics, an adherence evaluation to identify a best performing model out of the group of models.

Embodiment 2. The method as recited in any preceding embodiment, wherein each of the models in the group of models comprises a large language model (LLM).

Embodiment 3. The method as recited in any preceding embodiment, wherein the automated metrics comprise any one, or more, of: cosine similarity; BERTScore; BLEU; ROUGE; Meteor; BLEURT; and Perplexity.

Embodiment 4. The method as recited in any preceding embodiment, wherein each of the respective automated metrics is indicative of a performance of the model that generated the answer.

Embodiment 5. The method as recited in any preceding embodiment, wherein the adherence evaluation identifies an adherence of one of the automated metrics, and the adherence comprises an indication of an extent to which an evaluation of the performance of one of the models with that automated metric matches a human evaluation of the performance of that same model.

Embodiment 6. The method as recited in any preceding embodiment, wherein when the automated metrics exceed the threshold, a determination is made that a human evaluation of the battle is not needed, and when the automated metrics are lower than the threshold, a determination is made that a human evaluation of the battle is needed.

Embodiment 7. The method as recited in any preceding embodiment, wherein the adherence evaluation returns the automated metric that best describes, out of all of the automated metrics, a performance of the models.

Embodiment 8. The method as recited in any preceding embodiment, wherein an outcome of the adherence evaluation is used to select one of the models of the group of the models, as a best performing model.

Embodiment 9. The method as recited in any preceding embodiment, wherein an Elo rating is computed that is a performance measure for one or more of the models.

Embodiment 10. The method as recited in any preceding embodiment, wherein the human evaluation comprises a human evaluation battle.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

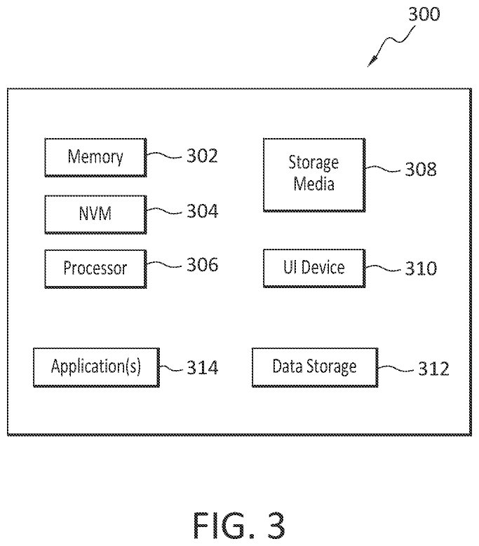

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
obtaining, for a benchmark question, a respective answer to the benchmark question generated by each model of a group of models;
computing respective automated metrics for each of the answers;
randomly selecting a battle between a first one of the models and a second one of the models and, for the automated metrics that respectively correspond to the answer generated by the first model and the answer generated by the second model, determining a respective difference between those automated metrics and a threshold;
determining, based on the respective differences, whether or not a human evaluation of the battle is needed;
using a set of agents to determine, by voting of the agents, as between the answer of the first model and the answer of the second model, which answer is better; and
performing, based on the voting and the automated metrics, an adherence evaluation to identify a best performing model out of the group of models.

2. The method as recited in claim 1, wherein each of the models in the group of models comprises a large language model (LLM).

3. The method as recited in claim 1, wherein the automated metrics comprise any one, or more, of: cosine similarity; BERTScore; BLEU; ROUGE; Meteor; BLEURT; and Perplexity.

4. The method as recited in claim 1, wherein each of the respective automated metrics is indicative of a performance of the model that generated the answer.

5. The method as recited in claim 1, wherein the adherence evaluation identifies an adherence of one of the automated metrics, and the adherence comprises an indication of an extent to which an evaluation of the performance of one of the models with that automated metric matches a human evaluation of the performance of that same model.

6. The method as recited in claim 1, wherein when the automated metrics exceed the threshold, a determination is made that a human evaluation of the battle is not needed, and when the automated metrics are lower than the threshold, a determination is made that a human evaluation of the battle is needed.

7. The method as recited in claim 1, wherein the adherence evaluation returns the automated metric that best describes, out of all of the automated metrics, a performance of the models.

8. The method as recited in claim 1, wherein an outcome of the adherence evaluation is used to select one of the models of the group of the models, as a best performing model.

9. The method as recited in claim 1, wherein an Elo rating is computed that is a performance measure for one or more of the models.

10. The method as recited in claim 1, wherein the human evaluation comprises a human evaluation battle.

11. A non-transitory storage medium having stored therein instructions that are executable by one or more hardware processors to perform operations comprising:
obtaining, for a benchmark question, a respective answer to the benchmark question generated by each model of a group of models;
computing respective automated metrics for each of the answers;
randomly selecting a battle between a first one of the models and a second one of the models and, for the automated metrics that respectively correspond to the answer generated by the first model and the answer generated by the second model, determining a respective difference between those automated metrics and a threshold;
determining, based on the respective differences, whether or not a human evaluation of the battle is needed;
using a set of agents to determine, by voting of the agents, as between the answer of the first model and the answer of the second model, which answer is better; and
performing, based on the voting and the automated metrics, an adherence evaluation to identify a best performing model out of the group of models.

12. The non-transitory storage medium as recited in claim 11, wherein each of the models in the group of models comprises a large language model (LLM).

13. The non-transitory storage medium as recited in claim 11, wherein the automated metrics comprise any one, or more, of: cosine similarity; BERTScore; BLEU; ROUGE; Meteor; BLEURT; and Perplexity.

14. The non-transitory storage medium as recited in claim 11, wherein each of the respective automated metrics is indicative of a performance of the model that generated the answer.

15. The non-transitory storage medium as recited in claim 11, wherein the adherence evaluation identifies an adherence of one of the automated metrics, and the adherence comprises an indication of an extent to which an evaluation of the performance of one of the models with that automated metric matches a human evaluation of the performance of that same model.

16. The non-transitory storage medium as recited in claim 11, wherein when the automated metrics exceed the threshold, a determination is made that a human evaluation of the battle is not needed, and when the automated metrics are lower than the threshold, a determination is made that a human evaluation of the battle is needed.

17. The non-transitory storage medium as recited in claim 11, wherein the adherence evaluation returns the automated metric that best describes, out of all of the automated metrics, a performance of the models.

18. The non-transitory storage medium as recited in claim 11, wherein an outcome of the adherence evaluation is used to select one of the models of the group of the models, as a best performing model.

19. The non-transitory storage medium as recited in claim 11, wherein an Elo rating is computed that is a performance measure for one or more of the models.

20. The non-transitory storage medium as recited in claim 11, wherein the human evaluation comprises a human evaluation battle.
